(19) United States
(12) Patent Application Publication
(10) Pub. No.: US 2009/0127724 A1
(43) Pub. Date: May 21, 2009

(54) Water aerating and controlling assembly for aquarium

(76) Inventor: Hsueh Lee Tsai, Yunlin Hsien (TW)

Correspondence Address: CHARLES E. BAXLEY, ESQUIRE, 90 JOHN STREET, SUITE 309, NEW YORK, NY, 10038, US

(21) Appl. No.: 11/986,477

(22) Filed: Nov. 21, 2007

(51) Int. Cl. B01F 3/04; C02F 1/74

(52) U.S. Cl. 261/64.1; 210/148; 210/143; 261/93

(57) ABSTRACT

A water aerating and controlling assembly for an aquarium includes an aerating device for attaching to a container of the aquarium, a gaseous reservoir coupled to the aerating device for supplying a gaseous material to the aerating device, and a controlling device for controlling the gaseous material to be selectively supplied to the aerating device when the gaseous reservoir is opened, such as during the day time, and for allowing an air or oxygen in an environment to flow into the aerating device and to be supplied to the water plants or the water weeds when the gaseous reservoir is closed, such as during the night time.

### BACKGROUND OF THE INVENTION

1. Field of the Invention

The present invention relates to a water aerating and controlling assembly for an aquarium, and more particularly to a water aerating and controlling assembly for attaching to an aquarium and for suitably supplying the carbon dioxide and/or the air into the water contained within the container and for suitably supplying the carbon dioxide and/or the air to the water plants or the water weeds received in the container.

2. Description of the Prior Art

Typical aquarium facilities comprise a pump disposed in a chamber of a container for circulating the water contained within the container and for pumping fresh air or carbon dioxide into the container and thus for airing or aerating purposes.

For example, U.S. Pat. No. 6,523,498 to Shyu discloses one of the typical aquariums having a powerless air pumping device and comprising an impeller disposed in a chamber of a container and arranged in a water flowing path for being powered by the flowing water.

However, the air pumping device may only be used to recycle the air contained in the water that is received within the container, but may not be used to suitably supply the carbon dioxide and/or the air into the water contained within the container and also may not suitably supply the carbon dioxide and/or the air to the water plants or the water weeds received in the container.

The present invention has arisen to mitigate and/or obviate the afore-described disadvantages of the conventional water aerating assemblies for aquarium facilities.

### SUMMARY OF THE INVENTION

The primary objective of the present invention is to provide a water aerating and controlling assembly for attaching to an aquarium for suitably supplying the carbon dioxide and/or the air into the water contained within the container and for suitably supplying the carbon dioxide and/or the air to the water plants or the water weeds received in the container.

The other objective of the present invention is to provide a water aerating and controlling assembly for controlling and supplying the carbon dioxide into the water during the day time, and for controlling and supplying the air and/or the oxygen into the water during the night time.

In accordance with one aspect of the invention, there is provided a water aerating and controlling assembly for an aquarium comprising an aerating device for attaching to a container of the aquarium and including an entrance, a gaseous reservoir for receiving a gaseous material, and coupled to the aerating device for supplying the gaseous material to the entrance of the aerating device, and a controlling device for controlling the gaseous material to be selectively supplied to the entrance of the aerating device when the gaseous reservoir is opened, and for allowing an air in an environment to flow into the entrance of the aerating device when the gaseous reservoir is closed.

The controlling device includes a casing having a chamber formed therein, and having an inlet port for coupling to the gaseous reservoir and for receiving the gaseous material from the gaseous reservoir, and having an outlet port for coupling to the entrance of the aerating device and for supplying the gaseous material to the aerating device.

The casing includes a lid for closing the chamber of the casing. The casing includes an opening formed therein for allowing the air in the environment to flow into the chamber of the casing.

The controlling device includes a spring blade attached to the casing for selectively blocking the opening of the casing and for controlling the air in the environment to flow into the chamber of the casing.

The casing includes at least one catch extended therein, and the spring blade includes at least one cavity formed therein for engaging with the catch of the casing and for attaching the spring blade to the casing.

The aerating device includes a pumping device having an impeller for pumping and impelling a water received in the container. The aerating device includes a receptacle attached to the pumping device for receiving the water pumped and impelled by the impeller, and includes at least one orifice formed therein for the water to flow out through the orifice of the receptacle, a tube disposed in the receptacle and disposed on the pumping device for forming an annular space between the receptacle and the tube and for receiving the water pumped by the impeller, the tube includes a bore formed therein for receiving the water and directed toward the impeller for supplying the water toward the impeller and for allowing the water to be pumped and impelled by the impeller.

The receptacle includes a tubular member extended in an upper portion of the receptacle for forming an annular chamber between the tubular member and the receptacle, and for forming an annular passageway between the tubular member and the tube, and the annular passageway between the tubular member and the tube is communicating with the annular space between the receptacle and the tube for allowing a gaseous material to flow upwardly through the annular space between the receptacle and the tube and the annular passageway between the tubular member and the tube and for allowing the gaseous material to be drawn into the bore of the tube, and the entrance of the receptacle is communicating with the annular chamber of the receptacle and coupled to the gaseous reservoir for receiving the gaseous material.

The tube includes at least one protrusion extended outwardly from the tube for agitating the water flowing into the annular space of the receptacle and for generating an eddy current. The receptacle includes an outlet member having the orifice formed therein, and a rotary member rotatably disposed in the outlet member and rotatable relative to the receptacle, the rotary member includes at least one aperture formed therein for rotatably and selectively aligning with the orifice of the outlet member.

The receptacle includes a cover disposed on top and having a hollow pipe extended upwardly therefrom and aligned with the tube, and a floating device slidably attached to the pipe of the cover. The floating device includes a conduit extended downwardly from a float and slidably engaged with the pipe for allowing the float to be adjusted up and down relative to the pipe.

The floating device includes at least one water inlet for receiving the water in an upper portion of the container and for allowing the water to flow into the float and to flow through the conduit and the pipe of the cover and to flow into the bore of the tube. The float includes a compartment formed in an outer peripheral wall, and a rotary wheel rotatably disposed in the compartment of the float.

The receptacle includes a ring member disposed on the tube and engaged between the tubular member and the tube, and the ring member includes a notch formed therein and communicating with the annular passageway between the tubular member and the tube for partially blocking the annular passageway between the tubular member and the tube.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a cross sectional view illustrating the operation of a water aerating and controlling assembly that is attached to an aquarium;

FIG. 2 is a cross sectional view similar to FIG. 1, illustrating the operation of the water aerating and controlling assembly;

FIG. 3 is a perspective view of the water aerating and controlling assembly;

FIG. 4 is a cross sectional view of the water aerating and controlling assembly taken along lines 4-4 of FIG. 3;

FIG. 5 is a cross sectional view taken along lines 5-5 of FIG. 4; and

FIG. 6 is a partial exploded view of the water aerating and controlling assembly.

### DETAILED DESCRIPTION OF THE PREFERRED EMBODIMENT

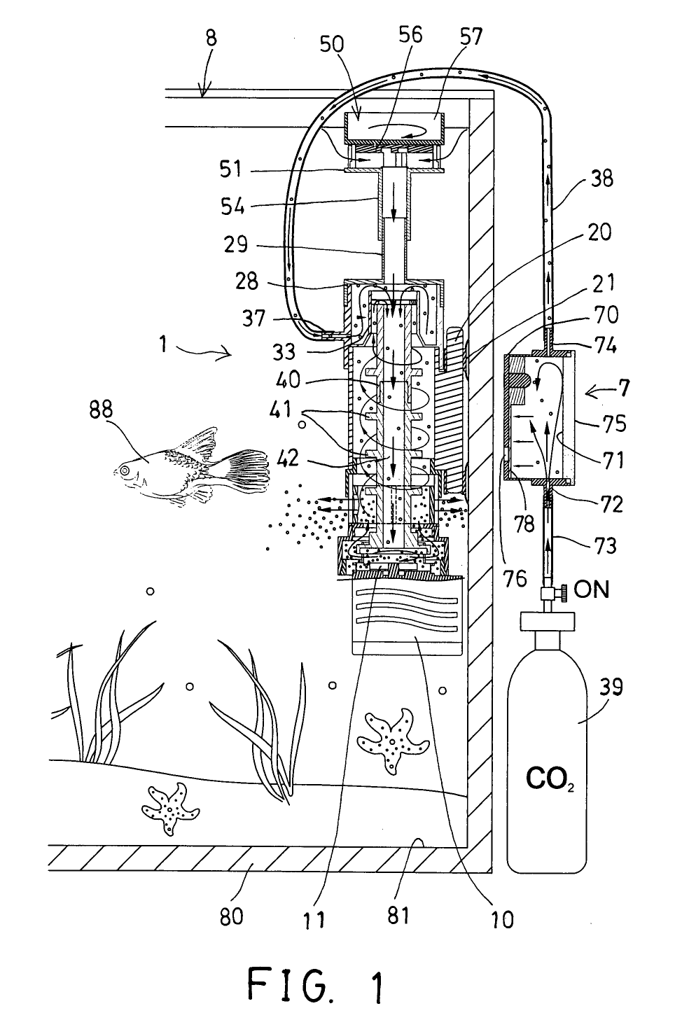

Referring to the drawings, and initially to FIGS. 1-4, a water aerating and controlling assembly in accordance with the present invention includes an aerating device 1 for attaching to an aquarium 8 which comprises a container 80 including a chamber 81 formed therein for receiving water and fish 88, and comprises a pumping device 10 for attaching to the interior of the container 80 with hooks or latches or fasteners or sucking cups (not shown) or the like, the pumping device 10 includes a powered or motorized impeller 11 for pumping or impelling the water. A receptacle 20 may be attached to the interior of the container 80 with hooks or latches or fasteners (not shown) or sucking cups 21 or the like, and disposed or attached to the pumping device 10.

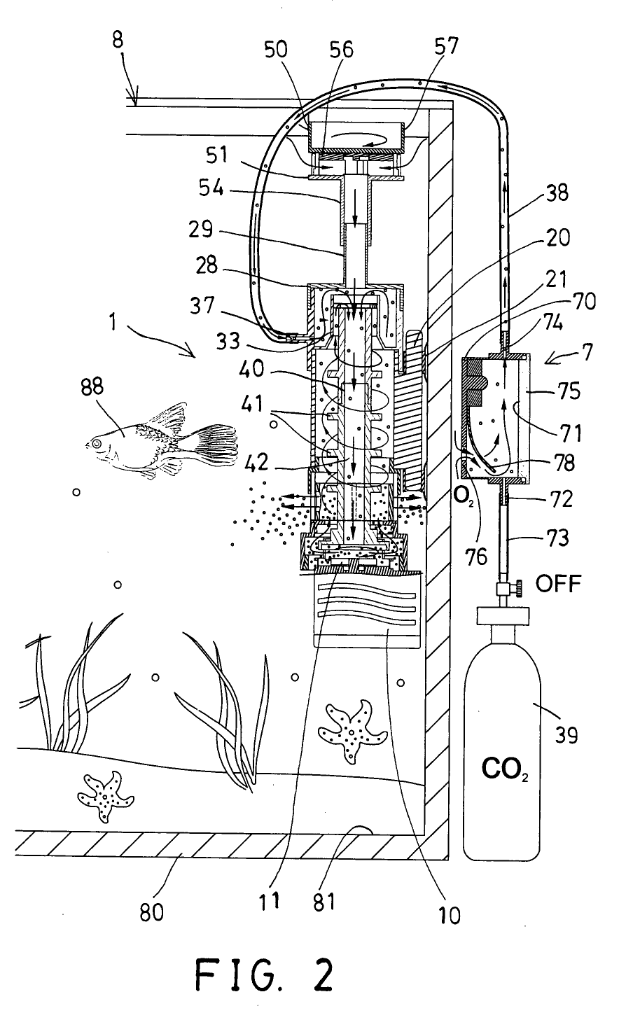

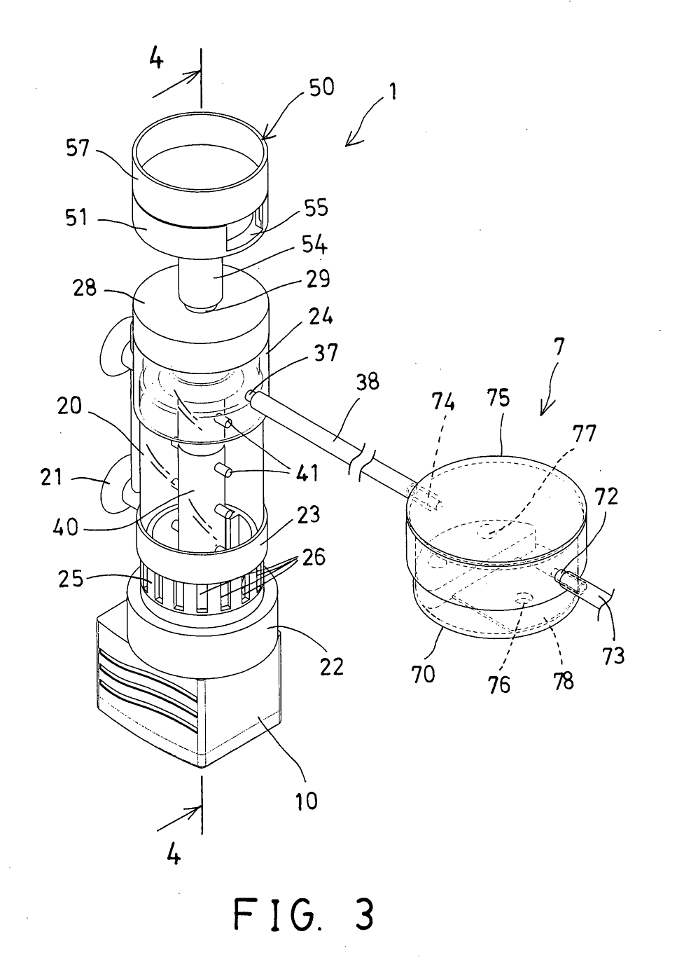

The receptacle 20 may include one or more housing members 22, 23, 24 assembled or secured or coupled together with such as force-fitted engagements, hooks or latches or fasteners (not shown) or with adhesive materials, or by welding processes, and may further include a screen or an outlet member 25 such as disposed between and secured to the housing members 22, 23 with such as force-fitted engagements, hooks or latches or fasteners (not shown) or with adhesive materials, or by welding processes, and having a number of orifices 26 formed therein (FIG. 3) for allowing the water to be pumped or impelled by the powered or motorized impeller 11 to flow out through the orifices 26 of the outlet member 25 of the receptacle 20 (FIGS. 1, 2).

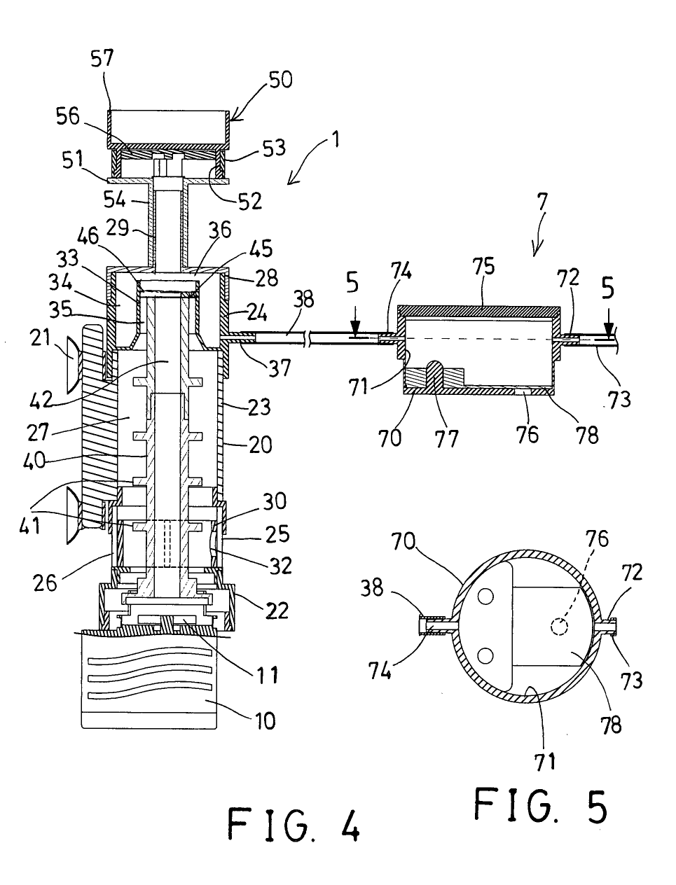

As shown in FIGS. 1-2, and 4, a rotary member 30 is rotatably disposed in the receptacle 20, and particularly disposed in the outlet member 25 of the receptacle 20 and rotatable relative to the receptacle 20. For example, the rotary member 30 includes one or more fins (not shown) extended therein, such as extended radially therein for being actuated by the water pumped or impelled by the powered or motorized impeller 11 and for allowing the rotary member 30 to be rotated or driven by the water flowing through the receptacle 20. The rotary member 30 includes one or more apertures 32 formed therein (FIG. 4) for rotatably or selectively aligning with the orifices 26 of the outlet member 25 of the receptacle 20 and for allowing the water to cyclically flow out through the orifices 26 of the outlet member 25 of the receptacle 20 and thus to suitably or evenly distribute the water out through the orifices 26 of the outlet member 25 of the receptacle 20.

The receptacle 20 may include a tube 40, such as a hollow tube 40 disposed or extended therein, such as disposed concentrically in the receptacle 20 and disposed on the pumping device 10 for forming an annular space 27 between the receptacle 20 and the tube 40 (FIGS. 1-2, 4), and includes one or more protrusions 41 extended outwardly from the tube 40 for agitating the water and for forming or generating an eddy current (FIGS. 1, 2), and thus for suitably agitating the water and the carbon dioxide and/or the air contained within the water in order to suitably agitate or to minimize the carbon dioxide and/or the air into a large amount of smaller air bubbles. The receptacle 20 may include a cover 28 disposed on top thereof and having a hollow pipe 29 extended upwardly therefrom and preferably aligned with the tube 40.

The tube 40 includes a bore 42 formed therein and aligned with or directed toward the pipe 29 of the cover 28 for receiving the water from the pipe 29 of the cover 28, and also aligned with or directed toward the pumping device 10 for directing or supplying the water toward the impeller 11 and for allowing the water to be pumped or impelled by the impeller 11 and then to flow out through the orifices 26 of the outlet member 25 of the receptacle 20. It is preferable that the receptacle 20 includes a tubular member 33 extended in such as the upper portion thereof or the upper housing member 24 for forming an annular chamber 34 between the tubular member 33 and the upper housing member 24, and also for forming an annular passageway 35 between the tubular member 33 and the tube 40, and communicating with the annular space 27 between the receptacle 20 and the tube 40 and arranged for allowing the carbon dioxide and/or the air to flow upwardly through the annular passageway 35 between the tubular member 33 and the tube 40.

As shown in FIG. 4, the upper portion of the tubular member 33 is slightly lower than the upper portion of the receptacle 20 and/or slightly lower than the cover 28 for forming a space or a gap 36 between the tubular member 33 and the cover 28, and the receptacle 20 may include an entrance 37 formed or provided in such as the upper portion thereof or the upper housing member 24 and communicating with the annular chamber 34 of the upper housing member 24, and coupled to a gas or fluid or carbon dioxide or other gaseous material reservoir or bottle 39 (FIGS. 1, 2) with a hose 38 for receiving the air and/or the carbon dioxide and for allowing the air and/or the carbon dioxide to flow or to be drawn into the annular chamber 34 of the upper housing member 24, and to flow through the gap 36 between the tubular member 33 and the cover 28 and then to be drawn into the bore 42 of the tube 40 and to be mixed or blended or supplied into the water that flows into the tube 40.

A ring member 45 is disposed or engaged onto the upper portion of the tube 40, and disposed or engaged between the tubular member 33 and the tube 40, and includes a notch 46 formed therein and communicating with the annular passageway 35 between the tubular member 33 and the tube 40 for partially blocking or closing the upper portion of the annular passageway 35 between the tubular member 33 and the tube 40 and for allowing the air and/or the carbon dioxide in the annular space 27 between the receptacle 20 and the tube 40 to flow or to be drawn through the notch 46 of the ring member 45 and then to be drawn into the bore 42 of the tube 40 (FIGS. 1, 2), such that the air and/or the carbon dioxide separated from the water and in the annular space 27 between the receptacle 20 and the tube 40 may be drawn into the water supplied into the bore 42 of the tube 40 and may be recycled.

A floating device 50 includes a float 51 having a compartment 52 formed or provided in an outer peripheral wall 53, and includes a conduit 54 extended downwardly therefrom and slidably engaged into or onto the outer peripheral portion of the pipe 29 of the cover 28 for allowing the float 51 to slide or to be adjusted up and down relative to the pipe 29 of the cover 28 (FIGS. 1, 2), and includes one or more water inlets 55 formed in such as the outer peripheral wall 53 (FIG. 3) for allowing the water in the upper portion of the container 80 to recycle or to flow into the compartment 52 of the float 51 and then to flow through the conduit 54 and the pipe 29 of the cover 28 and then to flow into the bore 42 of the tube 40. A paddle device or rotary wheel 56 is rotatably disposed in the compartment 52 of the float 51 and rotatably secured to the float 51 with a cap 57.

In operation, the water in the upper portion of the container 80 may flow through the water inlets 55 of the float 51 and may then flow into the compartment 52 of the float 51 to impel or to rotate the rotary wheel 56 relative to the float 51. As shown in FIGS. 1 and 2, the float 51 of the floating device 50 may be floated or buoyed on top of the water contained within the upper portion of the chamber 81 of the container 80 for allowing only the water at the upper portion of the chamber 81 of the container 80 to flow through the water inlets 55 of the float 51 and then to flow into the compartment 52 of the float 51, and thus to be supplied into the bore 42 of the tube 40 in order to be pumped and impelled by the impeller 11. The water supplied into the compartment 52 of the float 51 may be drawn through the conduit 54 and the pipe 29 of the cover 28 and may then be drawn into the bore 42 of the tube 40, and may then be drawn to flow into the lower portion of the chamber 81 of the container 80 again.

A portion of the water may be contained or received within the annular space 27 between the receptacle 20 and the tube 40 and may be caused to generate an eddy current by the powered or motorized impeller 11 and/or the protrusions 41 of the tube 40, and for allowing a portion of the air and/or the carbon dioxide, particularly the larger bubbles of the air and/or the carbon dioxide to be separated from the water and to be drawn through the notch 46 of the ring member 45 and then to be drawn into the bore 42 of the tube 40 such that the air and/or the carbon dioxide separated from the water and in the annular space 27 between the receptacle 20 and the tube 40 may be suitably recycled and may be suitably agitated or minimized into a large amount of smaller air bubbles. The above-described structure has been disclosed and filed in a co-pending U.S. patent application.

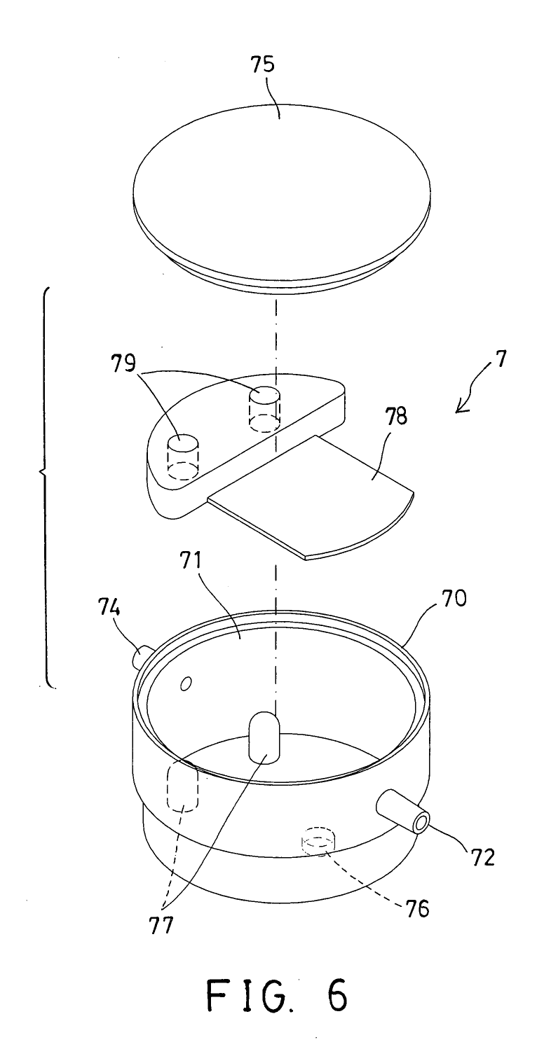

The water aerating and controlling assembly 1 in accordance with the present invention further comprises an air controlling means or device 7 (FIGS. 1-6) including a casing 70 having a chamber 71 formed therein for receiving the carbon dioxide and/or the air, and having an inlet port 72 for coupling to the carbon dioxide or gaseous reservoir or bottle 39 with such as a hose 73 and for receiving the air and/or the carbon dioxide from the gaseous reservoir or bottle 39, and having an outlet port 74 for coupling to the entrance 37 of the receptacle 20 with the hose 38 and thus for supplying the carbon dioxide and/or the gaseous material to the receptacle 20 of the aerating device 1, and having a lid 75 for closing the chamber 71 of the casing 70. The casing 70 includes an opening 76 formed therein for allowing the air in the environment to flow into the chamber 71 of the casing 70.

The air controlling device 7 further includes a check valve or spring blade 78 attached to the casing 70 for selectively closing or blocking the opening 76 of the casing 70 and for controlling the air in the environment to flow into the chamber 71 of the casing 70. For example, the casing 70 includes one or more catches 77 extended therein, and the check valve or spring blade 78 includes one or more cavities 79 formed therein for receiving or for engaging with the catches 77 of the casing 70 and for attaching or for securing the check valve or spring blade 78 to the casing 70. The resilience of the check valve or spring blade 78 is arranged for closing or blocking the opening 76 of the casing 70 when the carbon dioxide or gaseous reservoir or bottle 39 is opened or when the carbon dioxide or gaseous material flows out of the carbon dioxide or gaseous reservoir or bottle 39, and is arranged for opening the opening 76 of the casing 70 when the carbon dioxide or gaseous reservoir or bottle 39 is closed.

In operation, as shown in FIG. 1, when the bottle 39 is opened, the carbon dioxide or the gaseous material may flow out of the carbon dioxide or gaseous reservoir or bottle 39 and may flow into the chamber 71 of the casing 70 and then may be supplied into the receptacle 20 of the aerating device 1, particularly during the day time when the water plants or the water weeds received in the container are conducting the photosynthesis procedures. The gas or air pressure of the carbon dioxide or the gaseous material is arranged for closing or blocking the opening 76 of the casing 70 when the bottle 39 is opened.

As shown in FIG. 2, when the bottle 39 is closed and when the carbon dioxide or the gaseous material has not been supplied into the chamber 71 of the casing 70, the gas or air pressure in the chamber 71 of the casing 70 will be decreased, and the resilience of the check valve or spring blade 78 is arranged to be smaller than the air pressure in the outer environment for allowing the air in the environment to press against the check valve or spring blade 78 and to open the opening 76 of the casing 70 and thus to allow the air in the environment to flow into the chamber 71 of the casing 70 and then to allow the air or the oxygen to be supplied to the water plants or the water weeds and the fish 88 particularly during the night time when the water plants or the water weeds do not conduct the photosynthesis procedures.

Accordingly, the water aerating and controlling assembly in accordance with the present invention may be provided for attaching to an aquarium and for suitably agitating the water and the carbon dioxide and/or the air and for suitably supplying the carbon dioxide into the water contained within the container and for suitably supplying the carbon dioxide and/or the air to the water plants or the water weeds received in the container, and for controlling and supplying the carbon dioxide into the water during the day time, and for controlling and supplying the air and/or the oxygen into the water during the night time.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A water aerating and controlling assembly for an aquarium comprising:
an aerating device for attaching to a container of the aquarium and including an entrance,
a gaseous reservoir for receiving a gaseous material, and coupled to said aerating device for supplying the gaseous material to said entrance of said aerating device, and
means for controlling the gaseous material to be selectively supplied to said entrance of said aerating device when said gaseous reservoir is opened, and for allowing an air in an environment to flow into said entrance of said aerating device when said gaseous reservoir is closed.

2. The water aerating and controlling assembly as claimed in claim 1, wherein said controlling means includes a casing having a chamber formed therein, and having an inlet port for coupling to said gaseous reservoir and for receiving the gaseous material from said gaseous reservoir, and having an outlet port for coupling to said entrance of said aerating device and for supplying the gaseous material to said aerating device.

3. The water aerating and controlling assembly as claimed in claim 2, wherein said casing includes a lid for closing said chamber of said casing.

4. The water aerating and controlling assembly as claimed in claim 2, wherein said casing includes an opening formed therein for allowing the air in the environment to flow into said chamber of said casing.

5. The water aerating and controlling assembly as claimed in claim 4, wherein said controlling means includes a spring blade attached to said casing for selectively blocking said opening of said casing and for controlling the air in the environment to flow into said chamber of said casing.

6. The water aerating and controlling assembly as claimed in claim 5, wherein said casing includes at least one catch extended therein, and said spring blade includes at least one cavity formed therein for engaging with said at least one catch of said casing and for attaching said spring blade to said casing.

7. The water aerating and controlling assembly as claimed in claim 1, wherein said aerating device includes a pumping device having an impeller for pumping and impelling a water received in the container.

8. The water aerating and controlling assembly as claimed in claim 7, wherein said aerating device includes a receptacle attached to said pumping device for receiving the water pumped and impelled by said impeller, and includes at least one orifice formed therein for the water to flow out through said at least one orifice of said receptacle, a tube disposed in said receptacle and disposed on said pumping device for forming an annular space between said receptacle and said tube and for receiving the water pumped by said impeller, said tube includes a bore formed therein for receiving the water and directed toward said impeller for supplying the water toward said impeller and for allowing the water to be pumped and impelled by said impeller.

9. The water aerating and controlling assembly as claimed in claim 8, wherein said receptacle includes a tubular member extended in an upper portion of said receptacle for forming an annular chamber between said tubular member and said receptacle, and for forming an annular passageway between said tubular member and said tube, and said annular passageway between said tubular member and said tube is communicating with said annular space between said receptacle and said tube for allowing a gaseous material to flow upwardly through said annular space between said receptacle and said tube and said annular passageway between said tubular member and said tube and for allowing the gaseous material to be drawn into said bore of said tube, and said entrance of said receptacle is communicating with said annular chamber of said receptacle and coupled to said gaseous reservoir for receiving the gaseous material.

10. The water aerating and controlling assembly as claimed in claim 8, wherein said tube includes at least one protrusion extended outwardly from said tube for agitating the water flowing into said annular space of said receptacle and for generating an eddy current.

11. The water aerating and controlling assembly as claimed in claim 8, wherein said receptacle includes an outlet member having said at least one orifice formed therein, and a rotary member rotatably disposed in said outlet member and rotatable relative to said receptacle, said rotary member includes at least one aperture formed therein for rotatably and selectively aligning with said at least one orifice of said outlet member.

12. The water aerating and controlling assembly as claimed in claim 8, wherein said receptacle includes a cover disposed on top and having a hollow pipe extended upwardly therefrom and aligned with said tube, and a floating device slidably attached to said pipe of said cover.

13. The water aerating and controlling assembly as claimed in claim 12, wherein said floating device includes a conduit extended downwardly from a float and slidably engaged with said pipe for allowing said float to be adjusted up and down relative to said pipe.

14. The water aerating and controlling assembly as claimed in claim 13, wherein said floating device includes at least one water inlet for receiving the water in an upper portion of the container and for allowing the water to flow into said float and to flow through said conduit and said pipe of said cover and to flow into said bore of said tube.

15. The water aerating and controlling assembly as claimed in claim 13, wherein said float includes a compartment formed in an outer peripheral wall, and a rotary wheel rotatably disposed in said compartment of said float.

16. The water aerating and controlling assembly as claimed in claim 8, wherein said receptacle includes a ring member disposed on said tube and engaged between said tubular member and said tube, and said ring member includes a notch formed therein and communicating with said annular passageway between said tubular member and said tube for partially blocking said annular passageway between said tubular member and said tube.
